(19) United States
(12) Patent Application Publication
(10) Pub. No.: US 2015/0362097 A1
(43) Pub. Date: Dec. 17, 2015

(54) FOAM DUCT WITH CAPTURED INSERT FOR IMPROVED CONNECTABILITY

(71) Applicant: Unique Fabricating, Inc., Auburn Hills, MI (US)

(72) Inventors: Bradley J. Hazen, Rochester, MI (US); Daniel Bianchi, Auburn Hills, MI (US)

(73) Assignee: Unique Fabricating, Inc., Auburn Hills, MI (US)

(21) Appl. No.: 14/740,443

(22) Filed: Jun. 16, 2015

Related U.S. Application Data
(60) Provisional application No. 62/013,319, filed on Jun. 17, 2014.

(51) Int. Cl. F16L 9/133; B29C 65/00; B29C 65/02

(52) U.S. Cl. CPC F16L 9/133; B29C 65/02; B29C 66/53261; B29C 66/727; B29C 66/7315; B29C 66/73152; B29K 2623/06; B29L 2023/225

(57) ABSTRACT

The disclosure provides a hollow foam duct with an insert for improved connectability. The insert provides tactile and/or audible feedback to a user connecting a foam duct to, for example, an HVAC unit in an automobile. A method for making a foam duct is also disclosed.

### CROSS-REFERENCE TO RELATED APPLICATION

This application claims priority to U.S. provisional patent application No. 62/013,319 filed on Jun. 17, 2014, which is hereby incorporated by reference in its entirety.

### TECHNICAL FIELD

This disclosure relates to foam ducts. Foam ducts are generally light weight ducts that have many commercial uses, including in vehicles such as automobiles, airplanes, industrial vehicles, recreational vehicles and boats.

### BACKGROUND

In many industries, ducts have complex shapes. Generally, it is desirable to have ducts that are light weight and flexible, so they can readily be inserted into cavities. In the case of automotive ducts, the light weight component is particularly desirable. Automotive original equipment manufacturers, in particular, emphasize the benefits of light weight components.

As various manufacturers consider adopting foam ducts in lieu of prior hard plastic ducts and/or hybrid ducts, one of the considerations tends to be the connectability of the foam duct to members such as other automotive components and automotive structures such as HVAC units. For example, a hard plastic duct, when inserted into a cavity, may provide audible and/or tactile feedback for the assembler to recognize that the connection is secure. Additionally, because foam ducts are generally not as rigid as hard plastic ducts, consideration may be given to the quality of the connection and the durability of the connection of the foam duct to other components.

Thus, foam ducts are needed with improved connectability. Methods for making such foam ducts are also needed.

### BRIEF DESCRIPTION OF THE DRAWINGS

FIG. 1 is a perspective view of an exemplary hollow foam duct;

FIG. 2 is a perspective view of an exemplary hollow insert;

FIG. 3 is a top view of an exemplary hollow insert and an exemplary plug; and

FIG. 4 is a flow chart for an exemplary process of making a hollow foam duct.

### DETAILED DESCRIPTION

All figures and examples herein are intended to be non-limiting; they are mere exemplary iterations and/or embodiments of the claims appended to the end of this description. Modifications to structure, materials, the order of steps in procedures, temperature ranges, are contemplated.

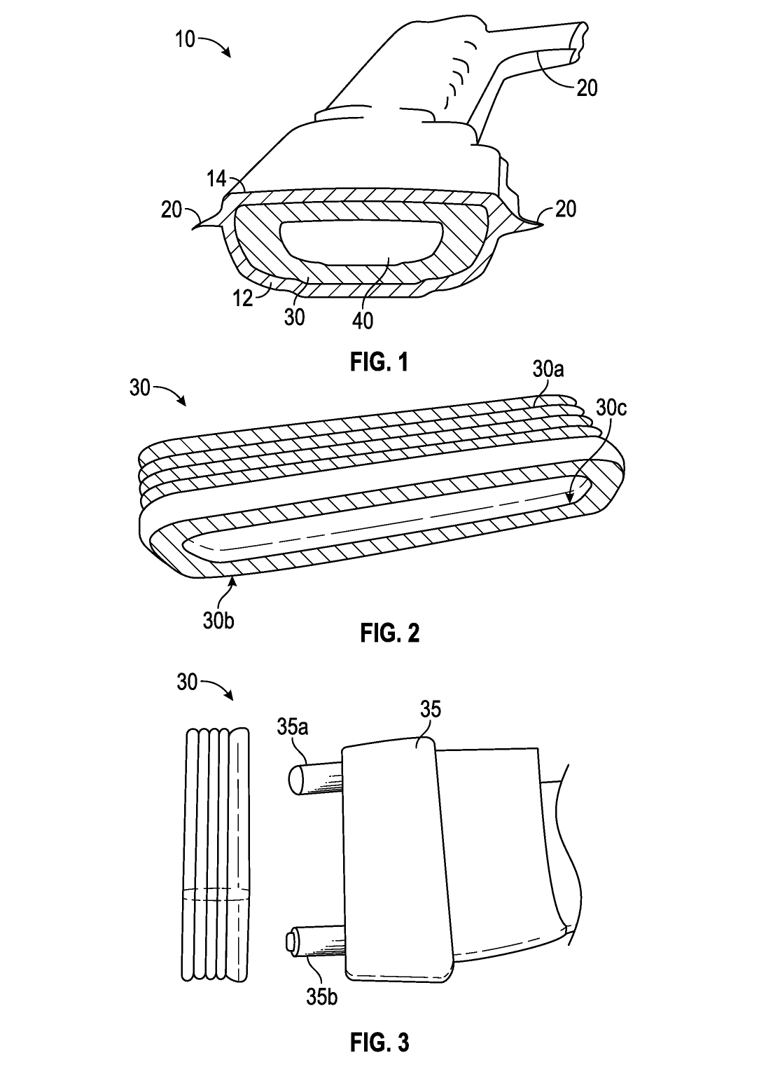

Referring to FIG. 1, an exemplary hollow foam duct 10 is shown. The exemplary hollow foam duct 10 was formed from two foam sheets, sheet 12 and sheet 14. The sheets may be connected by a thermoformed bond created by heat and pressure in a twin sheet forming tool. When such a tool is used, joints 20 may be visible on an exterior surface of the hollow foam duct 10. Hollow insert 30 may be thermoformed to the hollow foam body to form hollow foam duct 10. In such an instance, it may not be necessary to use an adhesive or a mechanical fastener to adhere the hollow insert 30 in the hollow foam body. Fluid, such as air, may flow through the opening 40 in the hollow foam duct 10.

Foam sheets 12 and 14 may be of the same or a different material. As a non-limiting example, the first foam sheet 12 and the second foam sheet 14 may be formed from a closed-cell, cross-linked polyolefin foam material. The first foam sheet 12 and the second foam sheet 14 may also be formed using a polyolefin foam blend comprising polypropylene and polyethylene. The percentage by weight of polypropylene and polyethylene in the polyolefin foam blend may vary as a result of the manufacturing process, but the percentage by weight of polypropylene may be higher than the percentage by weight of polyethylene. Suitable types of foam material are available through Toray Industries, Sekisui Voltek, Armacell, and Qycell Corporation. One non-limiting example may include Toray's Crosslinked Polyolefin Foam.

The first foam sheet 12 and the second foam sheet 14 may have the same or different density and/or thickness. One or the other or both may have a density in the range of about 2 lb/ft³ to 4.31 lb/ft³, and more specifically, a density of about 4 lb/ft3. The first foam sheet 12 and the second foam sheet 14 may also have a thickness of about 4 mm. Other thicknesses and densities are contemplated, including those higher and lower than the exemplified ranges.

Referring to FIGS. 1 and 2, the hollow foam duct 10 includes a hollow insert 30 therein. The hollow insert 30 may have a textured or shaped surface to facilitate connectivity. For example, hollow insert 30 has shaped adjoining ribs with peaks and valleys shown at 30a of its exterior surface. In the depicted embodiment, insert 30 is shaped as a series of ribs, where the outermost rib 30b at an endpoint of the hollow foam duct 10 has a larger circumference than other ribs in the configuration that are near the endpoint of the hollow foam duct 10. Other textures on the exterior surface of the insert 30 are contemplated. Textures may include regular or irregularly shaped and spaced protrusions or recesses, whether smooth or with one or more edges or ledges. Interior surface 30c may be textured or smooth. Interior surface 30c may also be treated, chemically or physically, to optimize for sound attenuation.

The hollow insert 30 may be made from many suitable thermoplastics, thermosets and/or foams. The hollow insert 30 may be formed using any of a number of manufacturing techniques, including injection molding and extrusion. In one embodiment, the hollow insert is a plastic material capable of producing audible and or tactile feedback when makes a physical mechanical connection. That is, when the hollow foam duct 10 is connected to a member in a host vehicle, hollow insert 10 may be configured to provide feedback to inform users a connection is secure.

In one embodiment, the hollow insert 30 has a compressive strength that is the same or higher than the compressive strength of foam sheets 12 and 14, which form the hollow foam body ultimately formed into hollow foam duct 10. In one embodiment, the hollow insert 30 has a tensile strength that is the same or higher than the tensile strength of foam sheets 12 and 14. In one embodiment, the hollow insert 30 has a hardness that is higher than that of foam sheets 12 and 14, wherein hardness refers generally to the resistance of the material to compression, indentation and scratching. Hollow insert 30 may be placed at the end or connection point of hollow foam duct 10. Hollow insert 30 may be configured to extend a predetermined distance into the hollow duct 10 from, on the low end of the range about 0.25 in to about 1.5 in, to on the high end of the range, from about 2 in to about 4 in. Shorter and longer depths are contemplated, depending on the nature and shape of the connection to be made.

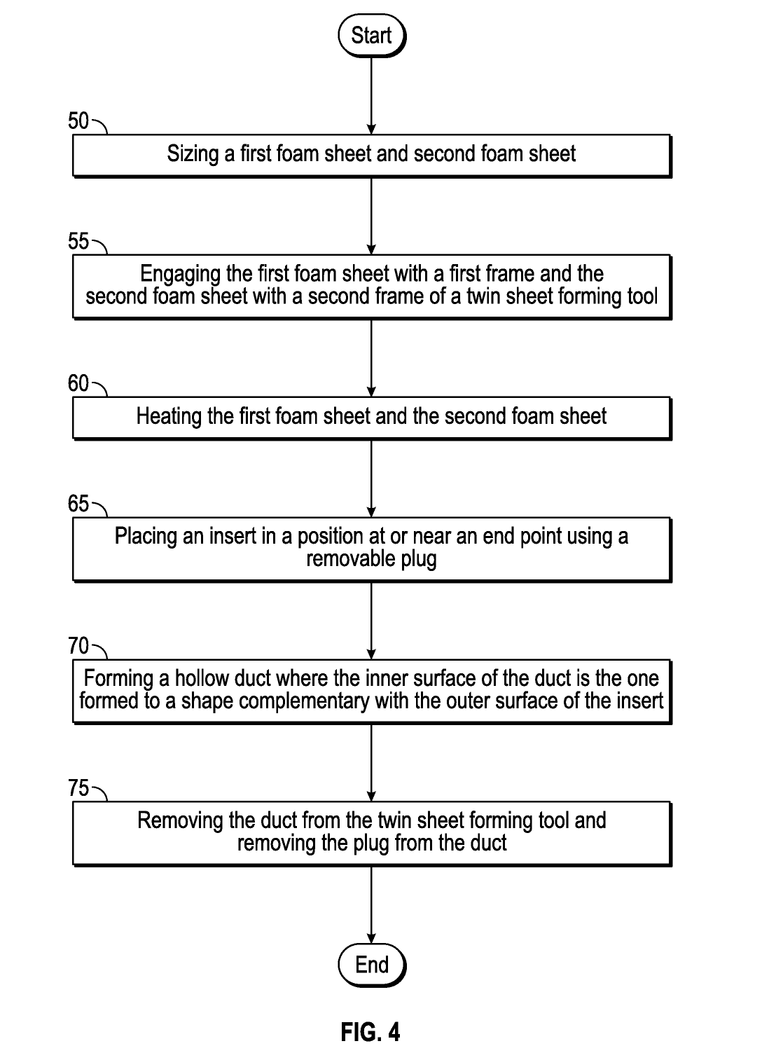

Referring to FIG. 3, a removable plug 35 is shown that may be used in the manufacture hollow foam duct 10. An exemplary manufacturing procedure is generally outlined in FIG. 4. In the depicted embodiment, there are two ports 35a and 35b, that permit air to pass during thermoforming. Plug 35 may operate as a shape former/retainer while permitting foam sheets 12 and 14 to remain removably fixed to frames of a twin sheet form tool and permitting passage of air via one or more ports so that upon removal from a twin sheet forming tool, the foam and/or plastic may retain the shape imparted during thermoforming. That is, passage of air during thermoforming may assist in avoiding collapse after removal from a twin sheet forming tool. Plug 35 may comprise any of a number of materials, and may be formed by any of a number of manufacturing processes, including injection molding. In one embodiment, plug 35 comprises, at least in part, a thermoset material. Materials for at least the outer surface of plug 35 should be readily removable from hollow insert 30 without tearing or other substantial damage to the integrity of hollow insert 30 or plug 35.

Referring to FIG. 4, an exemplary manufacturing method is shown. As one of skill in the art will appreciate, certain of the steps described may be performed in an order different from the one presented. Moreover, additional optional steps may be performed between the expressly described steps. In a scaled up manufacturing process, it is contemplated that a single action may perform steps described separately herein.

The first foam sheet 12 and the second foam sheet 14 are properly sized, see block 50. This may require the first foam sheet 12 and the second foam sheet 14 to be cut or trimmed to a specific length and/or width. The size of the first foam sheet 12 and the second foam sheet 14 may be determined by the size and shape of the hollow foam air duct 10 that will be formed. In certain applications, the size of the first foam sheet 12 and the second foam sheet 14 may also be determined by the size of the press and the dimensions of the upper mold tool and the lower mold tool which correspond to the design of the hollow foam air duct 10 being formed.

Before the hollow foam air duct 10 is formed, the first foam sheet 12 is engaged with a first frame and the second foam sheet 14 is engaged with a second frame, see block 55. The foam sheets may be engaged with the frames using hydraulically operated mechanical clamps or any other suitable fastening mechanisms for holding the foam sheets in place during a heating operation. By clamping the foam sheets to the frames, the foam sheets may also be kept in tension during heating.

The first foam sheet 12 and the first frame may be introduced into a heating operation. The process may occur in an oven or any structure capable of heating the first foam sheet to a predetermined temperature for a specific period of time. The second foam sheet 14 and the second frame may be introduced into the heating process at the same time as the first foam sheet or in close proximity to the first foam sheet, see block 55. The second foam sheet 14 and second frame may be introduced into the same oven or heating structure as the first foam sheet 12 or the second foam sheet 14 and second frame may be introduced into an alternate oven or heating structure.

The temperature and time period to complete the heating process are dependent on the density and the thickness of the foam sheets being used to form the foam air duct. In one example, the first foam sheet 12 and the second foam sheet 14 may be heated to a temperature in the range of about 250° F. to 400° F., see block 60. More specifically, the first foam sheet 12 and the second foam sheet 14 may be heated to a temperature of about 300° F. When the first foam sheet 12 and the second foam sheet 14 are heated within this temperature range, the sheets may be molded into the shape of the desired hollow foam air duct using the twin sheet forming tool including a press, the upper mold tool, and the lower mold tool, discussed in further detail below.

In block 60, a hollow insert 30 is placed in the twin sheet forming tool. In the depicted method, the hollow insert 30 is placed in the tool using a removable plug 35. The removable plug may be inserted into the hollow insert 30 via any of a number of methods, including the use of one or more air cylinders. The hollow insert 30 is positioned so that it is at or near what will become an end portion of a hollow foam duct 10.

Once the hollow insert 30 is in position and plugged with removable plug 35, and the first foam sheet 12 and the second foam sheet 14 are heated, the hollow foam duct 10 may be formed, see block 70. The forming process may include the upper tool mold and the lower tool mold of the twin sheet forming tool. The upper tool mold and the lower tool mold used in the forming process correlate to the design of the air duct needed for a particular vehicle.

In one exemplary operation, the first foam sheet 12 may be positioned adjacent to an interior surface of the upper tool mold and the second foam sheet 14 may be positioned adjacent to an interior surface of the lower tool mold. The upper tool mold and the lower tool mold may include channels or any other suitable structures capable of removing air. Accordingly, a vacuum pump or any other suitable device may be applied to the upper tool mold causing the first foam sheet to take the form of the interior surface of the upper tool mold. This may create a first section of the foam air duct. Similarly, a vacuum pump or any other suitable device may be applied to the lower tool mold causing the second foam sheet to take the form of the interior surface of the lower tool mold. This may create a second section of the foam air duct.

The upper tool mold and the lower tool mold may then be compressed together. The effect of the heated sheets and the pressure from the compression bonds the first section of the foam air duct and the second section of the foam air duct forming a unified hollow foam air duct with a hollow insert 30 therein, see block 70. Compression bonding also holds the insert 30 in place. That is, the insert 30 does not require adhesive to remain in position. The forming process causes the portion of the interior of the hollow foam duct 10 that contacts the exterior of hollow insert 30 to conform its shape to be complementary to the exterior of hollow insert 30.

Referring to block 75, the removable plug 35 is removed from the hollow foam air duct 10, and the hollow foam air duct 10 is removed from the twin sheet forming tool. These steps can be performed in an order conducive to efficient manufacturing processes. Any existing excess material, such as material around joints 20, may be removed.

With regard to the processes described herein, it should be understood that, although the steps of such processes, have been described as occurring in a certain sequence, such processes could be practiced with the described steps performed in an order other than the exemplary order. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined with reference to the appended claims along with the full scope of equivalents to which such claims are entitled. It is anticipated and intended that future developments will occur, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

What is claimed as new and desired to be protected by Letters Patent of the United States is:

1. A foam duct, comprising:
a hollow foam body having an interior surface and at least one end portion configured to attach to a member, the end portion having an opening; and
a hollow insert having a compressive strength equal to or greater than the foam body, the insert being attached to the interior surface of the foam body at or near the end portion, the attachment comprising a thermoformed bond, and the insert having an outer surface at least a portion of which is textured or shaped, the outer surface being adjacent a complementary textured or shaped inner surface of the hollow foam body.

2. The foam duct of claim 1, wherein the hollow foam body comprises at least one of polyethylene or polypropylene.

3. The foam duct of claim 1, wherein the hollow foam body consists essentially of a foam blend of polyethylene and polypropylene.

4. The foam duct of claim 1, wherein the hollow insert comprises a thermoset plastic material.

5. The foam duct of claim 1, wherein the hollow insert comprises a thermoplastic material.

6. The foam duct of claim 1, wherein the hollow insert has a tensile strength higher than the foam body.

7. The foam duct of claim 1, wherein the hollow insert has a hardness higher than the foam body.

8. The foam duct of claim 1, wherein the outer surface of the hollow insert has a shape including a series of spaced apart ribs.

9. A method of forming a hollow foam duct, comprising:
placing a hollow insert having an exterior surface, at least a portion of which is textured or shaped, into a twin sheet forming tool, wherein the placing step engages a removable plug in the hollow insert;
engaging a first foam sheet on one frame of the twin sheet forming tool and engaging a second foam sheet on a second frame of the twin sheet forming tool; and
thermoforming the first sheet, the second sheet and the hollow insert with the twin sheet forming tool to form the hollow foam duct.

10. The method of claim 9, further comprising removing the removable plug from the hollow foam duct and removing the hollow foam duct from the twin sheet forming tool.

11. The method of claim 9, wherein the hollow insert comprises a thermoset plastic material.

12. The method of claim 9, wherein the hollow insert comprises a thermoplastic material.

13. The method of claim 9, wherein the hollow insert has a tensile strength higher than the foam body.

14. The method of claim 9, wherein the hollow insert has a hardness higher than the foam body.

15. The method of claim 9, wherein the outer surface of the hollow insert has a shape including a series of spaced apart ribs.
